(19) United States
(12) Patent Application Publication
(10) Pub. No.: US 2025/0322377 A1
(43) Pub. Date: Oct. 16, 2025

(54) FINGERPRINT ENROLLMENT METHOD OF FINGERPRINT SMART CARD, FINGERPRINT SMART CARD, AND FINGERPRINT ENROLLMENT SYSTEM

(71) Applicant: Samsung Electronics Co., Ltd., Suwon-si (KR)

(72) Inventor: Jicheol KIM, Suwon-si (KR)

(73) Assignee: Samsung Electronics Co., Ltd., Suwon-si (KR)

(21) Appl. No.: 18/926,419

(22) Filed: Oct. 25, 2024

(30) Foreign Application Priority Data
Apr. 12, 2024 (KR) 10-2024-0049336

(51) Int. Cl. G06Q 20/20; G06Q 20/40

(52) U.S. Cl. CPC G06Q 20/204; G06Q 20/4012

(57) ABSTRACT

In a fingerprint enrollment method of a fingerprint smart card configured to communicate with a server and to enroll fingerprint information through a point of sale (POS) terminal, the method includes determining whether the fingerprint information is enrolled in the fingerprint smart card, performing a first authentication based on a user authenticator corresponding to the fingerprint smart card, in response to determining the fingerprint information is not enrolled in the fingerprint smart card, receiving the fingerprint information, in response to the first authentication being successfully completed, performing a second authentication based on the server and a personal identification number (PIN) code corresponding to the fingerprint smart card, storing the fingerprint information in the fingerprint smart card, in response to the second authentication being successfully completed, and omitting the first authentication and the second authentication in response to determining the fingerprint information is enrolled in the fingerprint smart card.

### CROSS-REFERENCE TO RELATED APPLICATION

This application claims priority under 35 USC § 119 to Korean Patent Application No. 10-2024-0049336 filed on Apr. 12, 2024 in the Korean Intellectual Property Office (KIPO), the contents of which are herein incorporated by reference in their entirety.

### BACKGROUND

### 1. Technical Field

Some example embodiments relate generally to smart cards, and more particularly to fingerprint enrollment methods of fingerprint smart cards, and fingerprint smart cards and fingerprint enrollment systems performing the fingerprint enrollment methods.

### 2. Description of the Related Art

In fingerprint recognition technology, a user's fingerprint may be recognized and enrolled, authentication process may be performed based on the enrolled fingerprint, and thus various security incidents may be reduced, or prevented. Fingerprint recognition technology may be applied to defense of individual and organizational network, protection of various contents and data, and safe access to financial information. Recently, smart cards that further include integrated circuit (IC) chips associated with fingerprint authentication have emerged. Therefore, technologies associated with smart cards equipped with the fingerprint authentication function are being studied.

### SUMMARY

At least some example embodiments of the inventive concepts provide a fingerprint enrollment method of a fingerprint smart card capable of efficiently using the fingerprint smart card and achieving relatively high security level.

At least some example embodiments of the inventive concepts provide a fingerprint smart card and a fingerprint enrollment system that perform the fingerprint enrollment method.

Some example embodiments disclose a fingerprint enrollment method of a fingerprint smart card configured to communicate with a server and to enroll fingerprint information through a point of sale (POS) terminal, the method including, determining whether the fingerprint information is enrolled in the fingerprint smart card, performing a first authentication based on a user authenticator corresponding to the fingerprint smart card, in response to determining the fingerprint information is not enrolled in the fingerprint smart card, receiving the fingerprint information, in response to the first authentication being successfully completed, performing a second authentication based on the server and a personal identification number (PIN) code corresponding to the fingerprint smart card, storing the fingerprint information in the fingerprint smart card, in response to the second authentication being successfully completed, and omitting the first authentication and the second authentication in response to determining the fingerprint information is enrolled in the fingerprint smart card.

Some example embodiments disclose, a fingerprint smart card configured to communicate with a server and to enroll fingerprint information through a point of sale (POS) terminal, the fingerprint smart card including a communicator configured to communicate with the POS terminal, a fingerprint sensor configured to obtain the fingerprint information, a storage configured to store the fingerprint information, and a controller configured to receive fingerprint information by the fingerprint sensor in response to a first authentication being successfully completed, the first authentication being performed, based on the POS terminal and a user authenticator corresponding to the fingerprint smart card, in response to the fingerprint information not being enrolled in the storage, and store the fingerprint information in the storage in response to a second authentication, performed based on the server and a personal identification number (PIN) code corresponding to the fingerprint smart card, being successfully completed.

Some example embodiments disclose, a fingerprint enrollment system including a fingerprint smart card including a storage configured to store fingerprint information, a point of sale (POS) terminal, a server storing a personal identification number (PIN) code, and processing circuitry configured to cause the system to determine whether the fingerprint information is enrolled in the storage in the fingerprint smart card, perform a first authentication based on a user authenticator corresponding to the fingerprint smart card, in response to determining the fingerprint information is not enrolled in the fingerprint smart card, perform a second authentication based on a PIN code corresponding to the fingerprint smart card. The PIN code is pre-stored in the server. When the fingerprint information is unenrolled in the storage in the fingerprint smart card, the first authentication is performed. When the first authentication is successfully completed, the fingerprint information is received and the second authentication is performed. When the second authentication is successfully completed, the fingerprint information is stored in the storage in the fingerprint smart card

In the fingerprint enrollment method of the fingerprint smart card, the fingerprint smart card, and the fingerprint enrollment system according to some example embodiments, a user of the fingerprint smart card may enroll the fingerprint information even if the user does not visit a bank. The user of the fingerprint smart card may use the fingerprint smart card efficiently. The fingerprint information may be enrolled by the first authentication based on the user authentication means and the second authentication based on the PIN code corresponding to the fingerprint smart card, and store the fingerprint information in the storage in the fingerprint smart card in response to the second authentication being successfully completed.

### BRIEF DESCRIPTION OF THE DRAWINGS

Illustrative, non-limiting example embodiments will be more clearly understood from the following detailed description taken in conjunction with the accompanying drawings.

FIG. 1 is a flowchart illustrating a fingerprint enrollment method of a fingerprint smart card according to some example embodiments.

FIGS. 2 and 3 are flowcharts illustrating examples of a first authentication in a fingerprint enrollment method of a fingerprint smart card according to some example embodiments.

FIG. 4 is a flowchart illustrating an example of a second authentication in a fingerprint enrollment method of a fingerprint smart card according to some example embodiments.

FIG. 5 is a flowchart illustrating a fingerprint enrollment method of a fingerprint smart card according to some example embodiments.

FIG. 6 is a flowchart illustrating an example of performing a fingerprint payment protocol in a fingerprint enrollment method of a fingerprint smart card according to some example embodiments.

FIG. 7 is a flowchart illustrating a fingerprint enrollment method of a fingerprint smart card according to some example embodiments.

FIG. 8 is a diagram illustrating a fingerprint smart card according to some example embodiments.

FIG. 9 is a diagram illustrating a POS terminal according to some example embodiments.

FIG. 10 is a diagram illustrating a fingerprint enrollment system according to some example embodiments.

FIGS. 11A, 11B, 11C, 11D, 11E, 11F, 11G, 11H, 11I, and 11J are diagrams for describing a fingerprint enrollment method of a fingerprint smart card according to some example embodiments.

FIG. 12 is a diagram illustrating an example of establishing communication between a POS terminal in a fingerprint enrollment method of a fingerprint smart card and a fingerprint smart card according to some example embodiments.

FIG. 13 is a diagram illustrating an example of a first authentication in a fingerprint enrollment method of a fingerprint smart card according to some example embodiments.

FIG. 14 is a block diagram illustrating an electronic system including a fingerprint smart card according to some example embodiments.

### DETAILED DESCRIPTION

Some example embodiments will be described more fully with reference to the accompanying drawings, in which some example embodiments are shown. The inventive concepts may, however, be embodied in many different forms and should not be construed as limited to the example embodiments set forth herein. Like reference numerals refer to like elements throughout this application.

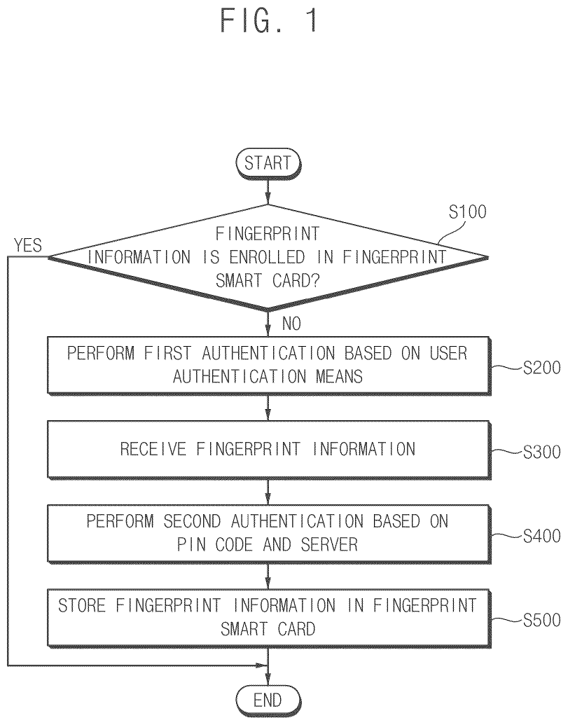

FIG. 1 is a flowchart illustrating a fingerprint enrollment method of a fingerprint smart card according to some example embodiments.

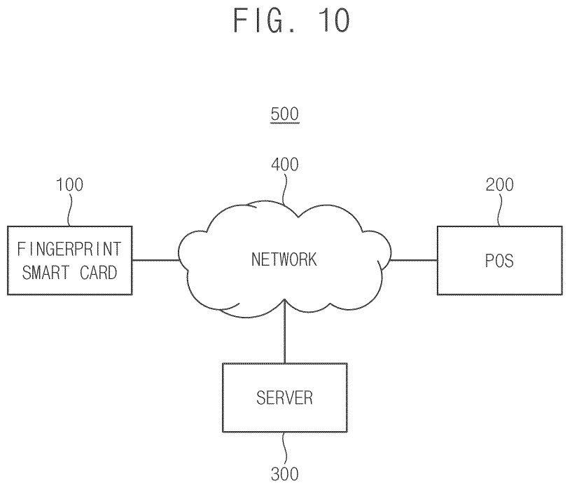

Referring to FIG. 1, a fingerprint enrollment method of a fingerprint smart card according to some example embodiments includes an operation S100, an operation S200, an operation S300, an operation S400, and/or an operation S500. The operations S100 to S500 may be or may include a process in which the fingerprint smart card enrolls fingerprint information based on a point of sale (POS) terminal and a server. A fingerprint enrollment system including the fingerprint smart card, the POS terminal, and the server will be described with reference to FIG. 10.

It is determined whether the fingerprint information is enrolled in the fingerprint smart card (the operation S100). For example, the fingerprint smart card may be a credit card that further includes a fingerprint sensor compared to a general credit card. For example, when the fingerprint smart card is not in use or is used for the first time, the fingerprint information may not be stored in the fingerprint smart card. For example, an operation of determining whether the fingerprint information is enrolled in the fingerprint smart card may be substantially the same as an operation of determining whether the fingerprint information is stored in the fingerprint smart card.

When the fingerprint information is enrolled in the fingerprint smart card (the operation S100: Yes), the operations S200 to S500 may not be performed or may be omitted. Therefore, the process may be terminated without enrolling the fingerprint information.

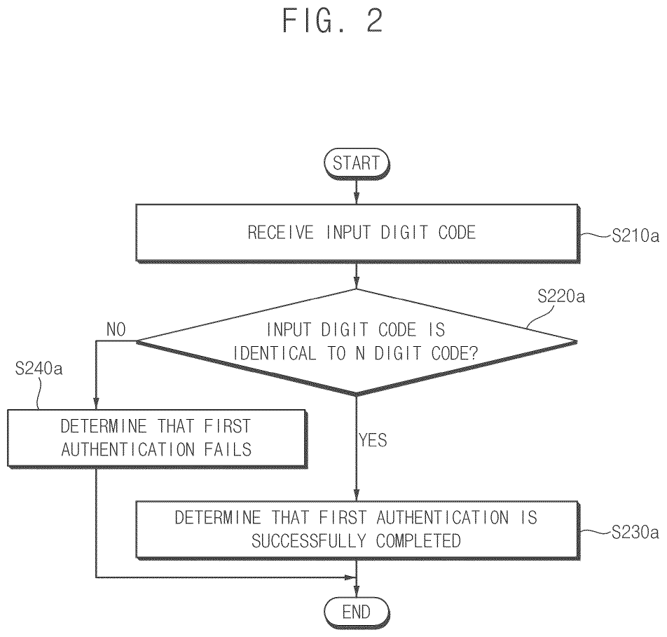

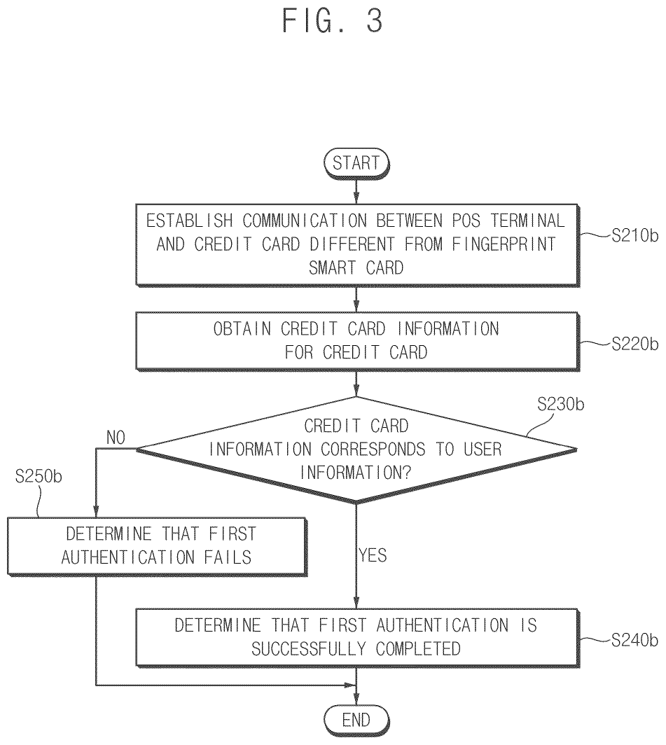

When the fingerprint information is not enrolled in the fingerprint smart card (the operation S100: No), a first authentication is performed based on a user authentication means (the operation S200). For example, the case where the fingerprint information is not enrolled in the fingerprint smart card may represent an initial state where the fingerprint smart card has never been used (e.g., immediately after the fingerprint smart card is issued, and/or before the fingerprint smart card is used after the fingerprint smart card is issued and delivered to the user). For example, the user authentication means may include any means for verifying that the user has an authority to use the fingerprint smart card. The user authentication means may be referred to as an authenticator herein. For example, the user authentication means may include an N digit code (N is a positive integer), and a user information associated with a user authorized to use the fingerprint smart card, etc. However, example embodiments are not limited thereto. The first authentication will be described with reference to FIGS. 2 and 3.

The fingerprint information is received (the operation S300). For example, the fingerprint information may be received using the fingerprint smart card. For example, the fingerprint smart card may include the fingerprint sensor, and the fingerprint information may be generated by touching a user's finger to the fingerprint sensor at least twice. For example, when the finger touches the fingerprint sensor at least twice, the accuracy or clarity of the fingerprint information may be improved.

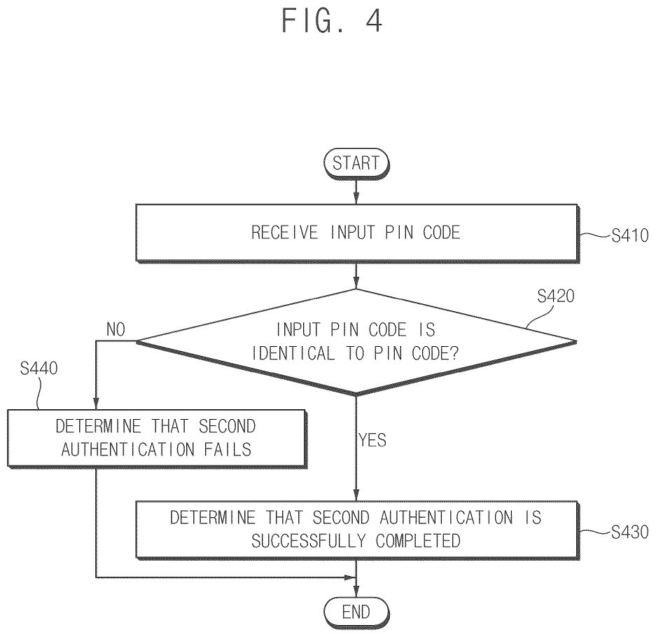

A second authentication is performed based on a personal identification number (PIN) code and the server (the operation S400). For example, the PIN code may be or may include a four digit code. For example, the user may set the PIN code when the user issues the fingerprint smart card. For example, the PIN code may be pre-stored in the server. The second authentication will be described with reference to FIG. 4.

For example, when the first authentication and the second authentication are successfully completed, it may indicate that the user has the authority to use the fingerprint smart card.

The fingerprint information is stored in the fingerprint smart card (the operation S500). For example, the fingerprint smart card may include a storage, and the fingerprint information may be stored in the storage. For example, when the fingerprint information is stored in the storage, it may indicate that fingerprint enrollment of the fingerprint smart card is successfully completed. For example, after the operation of storing the fingerprint information in the fingerprint smart card, an operation of notifying the server of the fingerprint enrollment of the fingerprint smart card may be additionally performed. For example, when the user authentication means includes the N digit code, a flag check function may be additionally performed. The flag check function may function to ignore even if a digit code identical to the N digit code is input after the fingerprint information is stored in the storage.

The fingerprint enrollment method of the fingerprint smart card according to some example embodiments may be performed by the POS terminal communicated with the fingerprint smart card. However, example embodiments are not limited thereto, and may be performed by various means capable of communicating with the fingerprint smart card, such as a smart phone.

In the fingerprint enrollment method of the fingerprint smart card according to some example embodiments, the user of the fingerprint smart card may enroll the fingerprint information even if the user does not visit a bank, and the user of the fingerprint smart card may use the fingerprint smart card efficiently. Therefore, example embodiments provide for a reduced, or minimized, cost to distribute fingerprint smart cards and/or a reduced, or minimized, inconvenience to the user while maintaining a relatively high security for enrollment. Additionally, the fingerprint information may be enrolled by the first authentication based on the user authentication means and the second authentication based on the PIN code, and relatively high security level may be achieved.

FIGS. 2 and 3 are flowcharts illustrating examples of a first authentication in a fingerprint enrollment method of a fingerprint smart card according to some example embodiments.

Referring to FIG. 2, an operation S210a, an operation S220a, an operation S230a, and/or an operation S240a may be included in an example of the operation S200 in FIG. 1. FIG. 2 illustrates a case where the user authentication means includes the N digit code (N is a positive integer).

An input digit code may be received (the operation S210a). For example, the input digit code may be input by the user using the POS terminal. For example, the POS terminal may include an output circuit (e.g., a display device), and a message instructing to input the input digit code may be displayed on the output circuit.

It may be determined whether the input digit code is identical to, or matches, the N digit code (the operation S220a). For example, the N digit code may be pre-stored in the storage in the fingerprint smart card. For example, the N digit code may be randomly set when manufacturing the fingerprint smart card, and the N digit code may be delivered to the user along with the fingerprint smart card. For example, since the fingerprint smart card and the N digit code are delivered after a user verification process, the N digit code may not be easily leaked to third parties other than a provider of the fingerprint smart card and the user provided with the fingerprint smart card.

When the input digit code is identical to, or matches, the N digit code (the operation S220a: Yes), it may be determined that the first authentication is successfully completed (the operation S230a). For example, when the N digit code is ‘123456’ and the input digit code received from the user is ‘123456’, it may be determined that the first authentication is successfully completed. In some example embodiments, although not illustrated in FIG. 2, when the first authentication is successfully completed, an operation of notification to proceed to operation S300 in FIG. 1 may be performed. For example, the POS terminal may output a message indicating that the first authentication is successfully completed associated with the operation S230a and a message requesting input of the fingerprint information associated with the operation S300.

When the input digit code is different from the N digit code (the operation S220a: No), it may be determined that the first authentication fails (the operation S240a). For example, when the N digit code is ‘123456’ and the input digit code input by the user is ‘456789’, it may be determined that the first authentication fails. In some example embodiments, although not illustrated in FIG. 2, when the first authentication fails, the POS terminal may output an error message indicating that the first authentication fails associated with the operation S240a.

Although FIG. 2 illustrates that the process is terminated when the first authentication fails, example embodiments are not limited thereto. For example, when the user may input the input digit code incorrectly due to a mistake or the like, the user may be given an opportunity to retry the first authentication a predetermined (or alternately given) number of times. For example, the predetermined (or alternately given) number of times may be M (M is a positive integer), the number of failures of the first authentication may be counted, and the first authentication may be performed several times based on the result of counting. For example, a first count value indicating the number of failures of the first authentication may be initially set to 0, and the first count value may be increased by 1 whenever the first authentication fails in the operation S240a. For example, when the first count value is less than M, the operations S210a and S220a may be performed again. For example, when the first count value is equal to M (e.g., when the first authentication fails even after M attempts), it may be determined that the first authentication has finally failed. For example, when the first authentication fails and the first count value is less than M, the POS terminal may output a message indicating that the user re-inputs the input digit code to perform the operation S210a again. For example, when the first authentication fails and the first count value is equal to M, the POS terminal may output a message indicating that the first authentication has finally failed.

Referring to FIG. 3, an operation S210b, an operation S220b, an operation S230b, an operation S240b, and/or an operation S250b may be included in an example of the operation S200 in FIG. 1. FIG. 3 illustrates a case where the user authentication means includes the user information associated with the user who has the authority to use the fingerprint smart card. For example, the user information may include a name, a date of birth, an identification number, etc. of the user authorized to use the fingerprint smart card.

It may be determined whether the user information corresponds to credit card information. For example, the user information may be compared with input user information obtained from the credit card information. Although some example embodiments are described in FIG. 3 based on the case where the input user information is obtained based on a credit card different from the fingerprint smart card, example embodiments are not limited thereto. For example, the input user information may be obtained by various means such as a check card, an account authentication, etc.

Although some example embodiments are described in FIG. 3 based on the case where a communication is established between the POS terminal and the credit card and the POS terminal automatically recognizes the credit card information, example embodiments are not limited thereto. For example, the user may manually input the credit card information.

The communication between the POS terminal and the credit card different from the fingerprint smart card may be established (the operation S210b). For example, the credit card may be a general credit card that does not include the fingerprint sensor. For example, the POS terminal and the credit card may establish the communication in a direct contact manner or in a contactless manner. For example, the POS terminal and the credit card may be directly contacted with each other in the direct contact manner, and the POS terminal and the credit card may not be directly contacted with each other in the contactless manner. For example, when the fingerprint smart card communicates with the POS terminal in the direct contact manner, the credit card may communicate with the POS terminal in the contactless manner. For example, when the fingerprint smart card communicates with the POS terminal in the contactless manner, the credit card may communicate with the POS terminal in the direct contact manner.

The credit card information for the credit card may be obtained (the operation S220b). For example, the POS terminal may obtain a card number, a validity number, etc. of the credit card through communication with the credit card. For example, the credit card information may include the card number, the validity number, etc. of the credit card.

It may be determined whether the credit card information corresponds to the user information (the operation S230b). For example, whether an operation of determining the credit card information corresponds to the user information may be substantially the same as an operation of determining whether the input user information is identical to, or matches, the user information. The input user information may be obtained based on the credit card information and the server. For example, the input user information may include the name, the date of birth, the identification number, etc. of the user authorized to use the credit card. For example, the identification number of the user authorized to use the credit card may be obtained from the card number of the credit card. For example, the user information may include the name, date of birth, identification number, etc. of the user authorized to use the fingerprint smart card.

For example, the user information corresponding to the fingerprint smart card may be pre-stored in the server. However, example embodiments are not limited thereto, and the user information may be pre-stored in the storage in the fingerprint smart card.

For example, the user information may correspond to the fingerprint smart card. For example, the POS terminal may obtain the user information corresponding to the fingerprint smart card through communication with the server.

For example, the input user information may correspond to the credit card information. For example, the POS terminal may obtain the input user information corresponding to the credit card information through communication with the server. For example, the input user information and the credit card information may be matched with each other and may be stored in the server. For example, the card number of the credit card and the identification number of the user authorized to use the credit card may be matched with each other and may be stored in the server. For example, the POS terminal may obtain the identification number corresponding to the card number of the credit card.

When the credit card information corresponds to the user information (operation S230b: Yes), it may be determined that the first authentication is successfully completed (the operation S240b). For example, when the identification number included in the user information is identical to, or matches, the identification number included in the input user information, it may be determined that the first authentication is successfully completed. In some example embodiments, although not illustrated in FIG. 3, when the first authentication is successfully completed, the operation of notification to proceed to operation S300 in FIG. 1 may be performed. For example, the POS terminal may output a message indicating that the first authentication has been successfully completed associated with the operation S230b and a message requesting input of fingerprint information associated with the operation S300.

When the credit card information does not correspond to the user information (the operation S230b: No), it may be determined that the first authentication fails (the operation S250b). For example, when the identification number included in the user information is different from the identification number included in the input user information, it may be determined that the first authentication fails.

Although FIG. 3 illustrates that the process is terminated when the first authentication fails, example embodiments are not limited thereto. For example, when the user may tag a credit card that does not belong to the user due to a mistake or the like, the user may be given an opportunity to retry the first authentication a predetermined (or alternately given) number of times. For example, the user may be given the opportunity to perform the operation S210b M times (M is a positive integer) using other credit cards different from the credit card. For example, when the first authentication fails even after M attempts, the POS terminal may output a message indicating that the first authentication has finally failed.

FIG. 4 is a flowchart illustrating an example of a second authentication in a fingerprint enrollment method of a fingerprint smart card according to some example embodiments.

Referring to FIG. 4, an operation S410, an operation S420, an operation S430, and/or an operation S440 may be an example of the operation S400 in FIG. 1.

An input pin code may be received (the operation S410). For example, the input pin code may be input by the user using the POS terminal. For example, the POS terminal may include the output circuit, and the message instructing to input the input PIN code may be displayed on the output circuit.

It may be determined whether the input PIN code is identical to, or matches, the PIN code (the operation S420). For example, the PIN code may be a four digit code. For example, the user may set the PIN code when the user issues the fingerprint smart card. For example, the PIN code may be pre-stored in the server. For example, the user may change the PIN code through a mobile phone, a computer, etc., and the changed PIN code may be stored in the server.

When the input PIN code is identical to, or matches, the PIN code (the operation S420: Yes), it may be determined that the second authentication is successfully completed (the operation S430). For example, when the PIN code is ‘7890’ and the input PIN code input by the user is ‘7890’, it may be determined that the second authentication is successfully completed. In some example embodiments, although not illustrated in FIG. 4, when the second authentication is successfully completed, an operation of notification to proceed to operation S500 in FIG. 1 may be performed. For example, the POS terminal may output a message indicating that the second authentication is successfully completed associated with the operation S430 and a message indicating that the fingerprint information is stored in the fingerprint smart card associated with the operation S500.

When the input PIN code is different from the PIN code (the operation S420: No), it may be determined that the second authentication fails (the operation S440). For example, when the PIN code is ‘7890’ and the input PIN code input by the user is ‘1234’, it may be determined that the second authentication fails. In some example embodiments, although not illustrated in FIG. 4, when the second authentication fails, the POS terminal may output an error message.

Although FIG. 4 illustrates that the process is terminated when the second authentication fails, some example embodiments are not limited thereto. For example, when the user may input the input PIN code incorrectly due to a mistake or the like, the user may be given an opportunity to retry the second authentication a predetermined (or alternately given) number of times. For example, the predetermined (or alternately given) number of times may be K (K is a positive integer), the number of failures of the second authentication may be counted, and the second authentication may be performed several times based on the result of counting. For example, a second count value indicating the number of failures of the second authentication may be initially set to 0, and the second count value may be increased by 1 whenever the second authentication fails in the operation S440. For example, when the second count value is less than K, the operations S410 and S420 may be performed again. For example, when the second count value is equal to K (e.g., when the second authentication fails even after K attempts), it may be determined that the second authentication has finally failed. For example, when the second authentication fails and the second count value is less than K, the POS terminal may output a message indicating that the user re-inputs the input PIN code to perform the operation S410 again. For example, when the second authentication fails and the second count value is equal to K, the POS terminal may output a message indicating that the second authentication has finally failed.

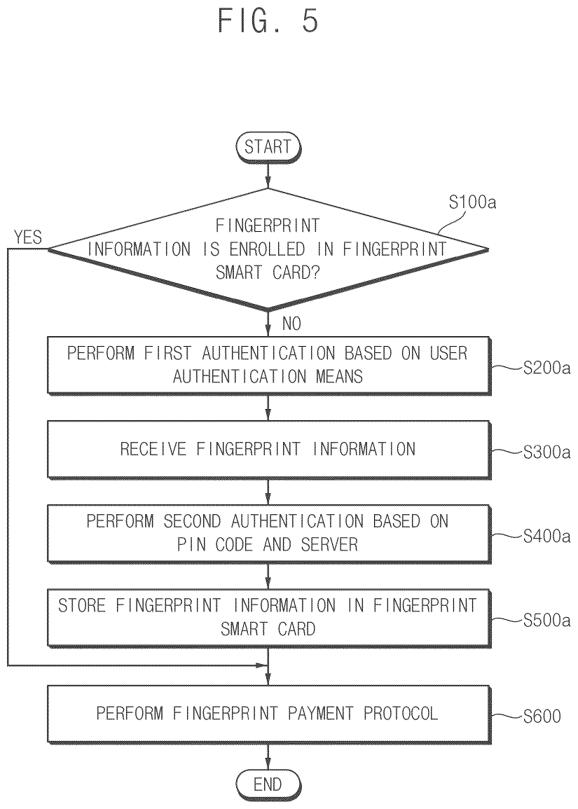

FIG. 5 is a flowchart illustrating a fingerprint enrollment method of a fingerprint smart card according to some example embodiments.

Referring to FIG. 5, the fingerprint enrollment method of the fingerprint smart card according to some example embodiments may include an operation S100a, an operation S200a, an operation S300a, an operation S400a, an operation S500a, and/or an operation S600. The operations S100a to S500a may be substantially the same as the operations S100 to S500 in FIG. 1, respectively. Hereinafter, the descriptions repeated with or overlapping with descriptions of FIG. 1 will be omitted in the interest of brevity.

After the fingerprint information is enrolled in the fingerprint smart card, a fingerprint payment protocol may be performed (the operation S600). For example, the fingerprint payment protocol may be performed when the fingerprint information is already enrolled in the fingerprint smart card (the operation S100a: Yes), or when the fingerprint information is not enrolled in the fingerprint smart card (step S100a: No) and the operations S200a to S500a are performed. For example, the fingerprint payment protocol may be a protocol for paying for goods/services purchased using the fingerprint smart card. For example, when the fingerprint payment protocol is performed, a payment may be performed based on a comparison result between input fingerprint information and the fingerprint information stored in the storage in the fingerprint smart card.

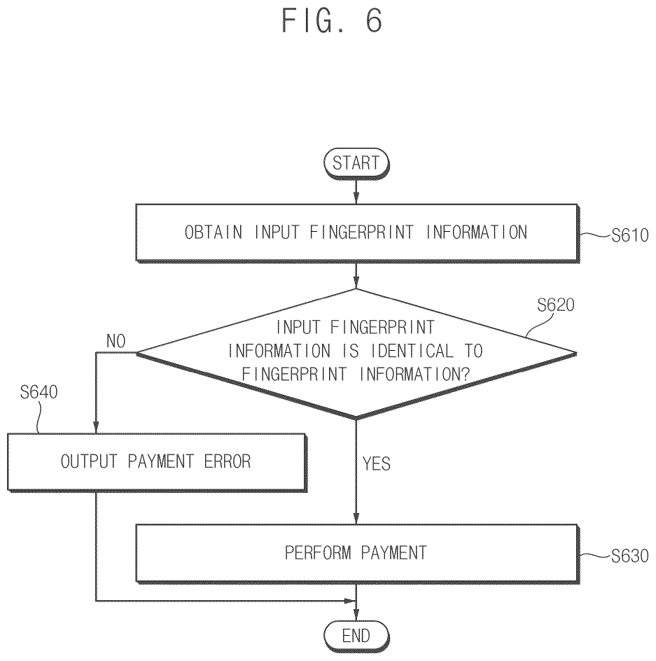

FIG. 6 is a flowchart illustrating an example of performing a fingerprint payment protocol in a fingerprint enrollment method of a fingerprint smart card according to some example embodiments.

For example, an operation S610, an operation S620, an operation S630, and/or an operation S640 may be an example of the operation S600 in FIG. 5.

The input fingerprint information may be obtained (the operation S610). For example, the fingerprint smart card may include the fingerprint sensor, and the input fingerprint information may be obtained using the fingerprint sensor.

It may be determined whether the input fingerprint information is identical to, or matches, the fingerprint information (the operation S620). For example, the fingerprint information may be stored in the storage in the fingerprint smart card through the operations S100 to S500 in FIG. 1. For example, since the fingerprint information may not be completely identical to the input fingerprint information, when it is determined that the fingerprint information and the input fingerprint information are similar to a certain level or more, (e.g. above a certain threshold) it may be determined that the input fingerprint information is identical to, or matches, the fingerprint information. Since an operation of comparing the fingerprint information and the input fingerprint information to determine whether the input fingerprint information is identical to, or matches, the fingerprint information is widely known to those skilled in the art, description will be omitted in the interest of brevity.

When the input fingerprint information is identical to, or matches, the fingerprint information (the operation S620: Yes), the payment may be performed (the operation S630). For example, the payment may be performed based on the fingerprint smart card, the POS terminal, and the server.

When the input fingerprint information is different from the fingerprint information (the operation S620: No), the payment may not be performed and a payment error may be output (the operation S640). For example, the POS terminal may output a message that the input fingerprint information is different from the fingerprint information.

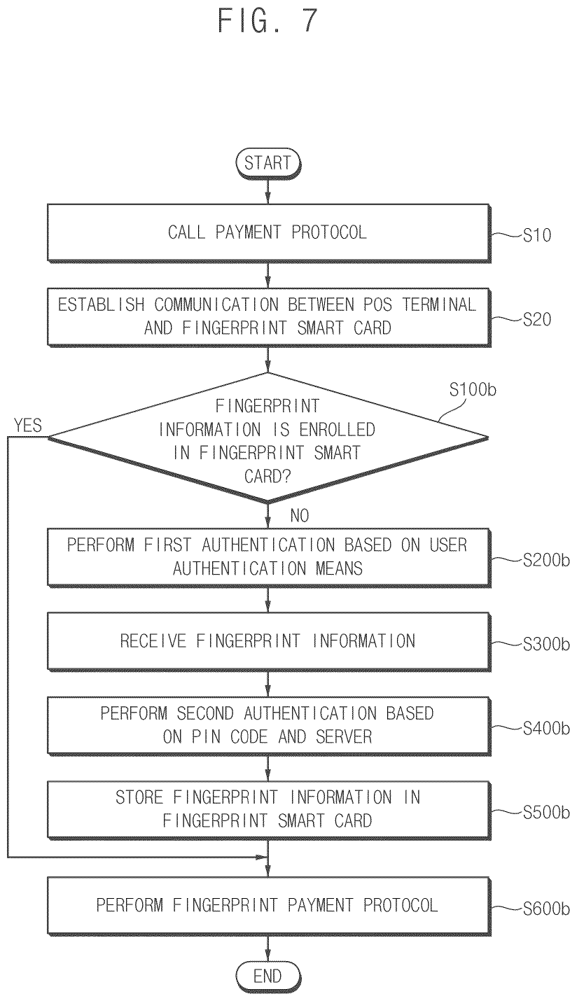

FIG. 7 is a flowchart illustrating a fingerprint enrollment method of a fingerprint smart card according to some example embodiments.

Referring to FIG. 7, the fingerprint enrollment method of the fingerprint smart card according to some example embodiments may include an operation S10, an operation S20, an operation S100b, an operation S200b, an operation S300b, an operation S400b, an operation S500b, and/or an operation S600b. The operations S10 and S20 may be performed before the operation S100b. The operations S100b to S500b may be substantially the same as the operations S100 to S500 in FIG. 1, and the operation S600b may be substantially the same as the operation S600 in FIG. 5. Hereinafter, the descriptions repeated with or overlapping with descriptions of FIGS. 1 and 5 will be omitted in the interest of brevity.

A payment protocol stored in the POS terminal may be called (the operation S10). For example, the payment protocol may include an operation of authenticating a payment request from the fingerprint smart card and an operation of providing payment information to the server. For example, the server may complete the payment electronically based on the payment information.

For example, the payment protocol may include the fingerprint payment protocol in the operation S600b. For example, the payment protocol may further include a general payment protocol for performing payment using general credit card other than the fingerprint smart card. For example, the operations S100b to S500b may be referred to as a fingerprint enrollment protocol.

A communication may be established between the POS terminal and the fingerprint smart card (the operation S20). For example, when the POS terminal establishes communication with a general credit card other than the fingerprint smart card, the fingerprint enrollment protocol and the fingerprint payment protocol may not be performed. In some example embodiments, the POS terminal may communicate with the fingerprint smart card in a direct contact manner. In some example embodiments, the POS terminal may communicate with the fingerprint smart card in a contactless manner.

Although some example embodiments are described in FIG. 7 based on the case of establishing the communication between the POS terminal and the fingerprint smart card after calling the payment protocol, example embodiments are not limited thereto. For example, after establishing the communication between the POS terminal and the fingerprint smart card, the payment protocol may be called.

For example, some example embodiments may be implemented in the form of products including computer-readable program code stored in a computer-readable medium. The computer-readable program code may be provided to a processor of various computers or other data processing devices. The computer-readable medium may be a computer-readable signal medium or a computer-readable recording medium. The computer-readable recording medium may be any tangible medium capable of storing or containing a program in or connected to an instruction execution system, equipment, and/or device. For example, the computer-readable medium may be provided in the form of a non-transitory storage medium. Here, non-transitory only means that the storage medium does not contain signals and is tangible, and does not distinguish whether the data is stored semi-permanently or temporarily in the storage medium.

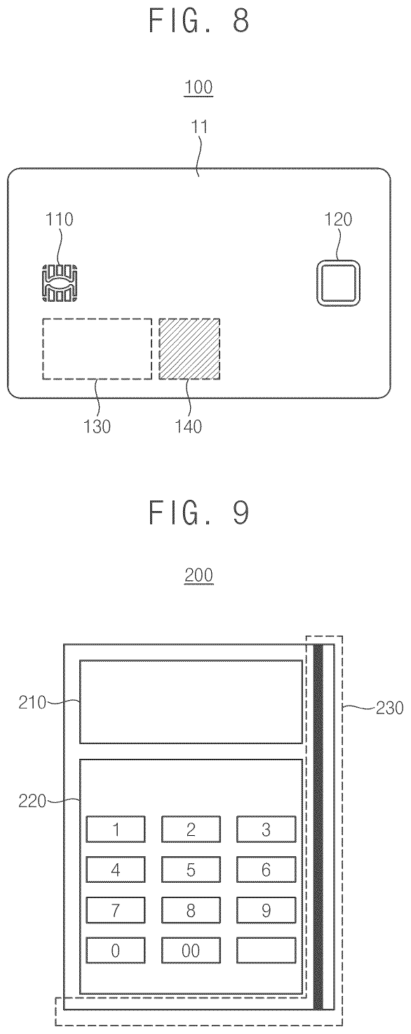

FIG. 8 is a diagram illustrating a fingerprint smart card according to some example embodiments.

Referring to FIG. 8, a fingerprint smart card 100 includes a communicator 110, a fingerprint sensor 120, a storage 130, and/or a controller 140.

The communicator 110 may perform communication with a POS terminal. For example, the communicator 110 may include a terminal contact pad, and when the POS terminal communicates with the fingerprint smart card 100 in a direct contact manner, the communicator 110 may directly contact with the POS terminal through the terminal contact pad.

Although not illustrated in FIG. 8, the communicator 110 may further include a plurality of antenna coils for communication with the POS terminal in a contactless manner. For example, when the POS terminal communicates with the fingerprint smart card 100 in a contactless manner, communication may be performed using the plurality of antenna coils.

The fingerprint sensor 120 may obtain fingerprint information. For example, the fingerprint information may be obtained based on at least one of various methods (or schemes) such as an optical method, a capacitive method, an ultrasonic method, a thermal detection method, etc. However, example embodiments are not limited thereto.

In some example embodiments, as illustrated in FIG. 8, the fingerprint sensor 120 may be spaced apart from the communicator 110. However, example embodiments are not limited thereto, and the fingerprint sensor 120 may be adjacent to the communicator 110.

In some example embodiments, as illustrated in FIG. 8, the communicator 110 and the fingerprint sensor 120 may be exposed through the same side (e.g., the front) of the fingerprint smart card 100. However, example embodiments are not limited thereto, and the communicator 110 and the fingerprint sensor 120 may be exposed through different sides of the fingerprint smart card 100. For example, the communicator 110 may be exposed through the front of the fingerprint smart card 100 and the fingerprint sensor 120 may be exposed through the rear of the fingerprint smart card 100.

The storage 130 may store the fingerprint information. For example, the storage 130 may pre-store N digit code (N is a positive integer) and user information included in a user authentication means. For example, the storage 130 may be a partial area of an integrated circuit (IC) chip of the fingerprint smart card 100, or may be a separate chip for information storage.

In some example embodiments, the storage 130 may include a security element that processes and/or stores security data such as a cryptographic key, a sensitive data, and/or a key code. For example, the secure elements may have a function of being tamper-resistant to protect against tampering attacks such as microprobing, software attacks, eavesdropping, fault injection, etc.

In some example embodiments, the storage 130 may include a non-volatile memory that retains the N digit code and the user information. For example, the non-volatile memory may include a flash memory, a phase-change random access memory (PRAM), a resistive random access memory (RRAM), a magnetic random access memory (MRAM), a ferroelectric random access memory (FRAM), etc.

The controller 140 may control the operations of the communicator 110, the fingerprint sensor 120, and/or the storage 130. For example, the storage 130 may be a partial area of the IC chip of the fingerprint smart card 100. For example, the controller 140 may include random signal/data processing device, such as a micro-controller unit (MCU).

In some example embodiments, when the fingerprint information is not enrolled in the storage 130, a first authentication is performed based on the user authentication means corresponding to the fingerprint smart card 100 and the POS terminal. When the first authentication is successfully completed, the fingerprint information may be received using the fingerprint sensor 120, and a second authentication may be performed based on a server and a PIN code corresponding to the fingerprint smart card 100. When the second authentication is successfully completed, the fingerprint information may be stored in the storage 130.

According to some example embodiments, part or all, or one or more, of the communicator 110, the fingerprint sensor 120, the storage 130, and/or the controller 140 may be integrated and implemented as one element, or may be implemented separately as two or more elements.

FIG. 9 is a diagram illustrating a POS terminal according to some example embodiments.

Referring to FIG. 9, a POS terminal 200 may include an output circuit 210, an input circuit 220, and/or a terminal communication circuit 230.

The output circuit 210 may display a message. For example, the output circuit 210 may display an information delivery message and/or a guidance message for performing the next operation whenever the operations S100 to S400 in FIG. 1 are completed. For example, the output circuit 210 may display an error message when at least one of the operations S100 to S400 in FIG. 1 fails.

The input circuit 220 may be a configuration for receiving an input digit code. For example, the input circuit 220 may include a plurality of number pads. However, example embodiments are not limited thereto, and the input circuit 220 may include a touch pad, etc. For example, while the first authentication and/or the second authentication are performed, the plurality of number pads included in the input circuit 220 may be used.

The terminal communication circuit 230 may communicate with the fingerprint smart card and/or the server. For example, the terminal communication circuit 230 may include both a configuration for communicating with the fingerprint smart card in a direct contact manner and a configuration for communicating with the fingerprint smart card in a contactless manner. For example, communication may be established between the POS terminal 200 and the fingerprint smart card through the terminal communication circuit 230. For example, communication may be established between the POS terminal 200 and a credit card different from the fingerprint smart card through the terminal communication circuit 230. For example, the terminal communication circuit 230 may communicate with the server wired and/or wirelessly.

FIG. 10 is a diagram illustrating a fingerprint enrollment system according to some example embodiments.

Referring to FIG. 10, a fingerprint enrollment system 500 includes a fingerprint smart card 100, a POS terminal 200, and/or a server 300. The fingerprint enrollment system 500 may further include a network 400.

The fingerprint smart card 100 may be a configuration for performing the fingerprint enrollment method according to some example embodiments described above with reference to FIGS. 1 to 7, and may include the fingerprint smart card according to some example embodiments described above with reference to FIG. 8. For example, the fingerprint smart card 100 may include a storage that stores fingerprint information. For example, the fingerprint smart card 100 may transmit a payment request to a POS terminal 200.

The POS terminal 200 may be a configuration for performing the fingerprint enrollment method according to some example embodiments described above with reference to FIGS. 1 to 7, and may include the POS terminal according to some example embodiments described above with reference to FIG. 9. For example, the POS terminal 200 may determine whether fingerprint information is enrolled in the storage in the fingerprint smart card 100. For example, the POS terminal 200 may perform a first authentication based on a user authentication means corresponding to the fingerprint smart card 100. For example, the POS terminal 200 may perform a second authentication based on a PIN code corresponding to the fingerprint smart card 100.

The server 300 may be a configuration for performing the fingerprint enrollment method according to some example embodiments described above with reference to FIGS. 1 to 7. For example, the PIN code may be pre-stored in the server 300. For example, user information associated with a user who has an authority to use the fingerprint smart card 100 included in the user authentication means may be pre-stored in the server 300.

Network 400 may be implemented as a wired network such as a local area network (LAN), a wide area network (WAN), and/or a value added network (VAN), and/or may be implemented as a wireless network such as a mobile radio communication network, a near field communication network, and/or a satellite communication network. For example, the network 400 may be a comprehensive data communication network that allows the fingerprint smart card 100, the POS terminal 200, and/or the server 300 to communicate smoothly with each other, and may include a wired Internet, a wireless Internet, and/or a mobile wireless communication network.

The fingerprint enrollment system 500 may perform the fingerprint enrollment method according to some example embodiments described above with reference to FIGS. 1 to 7. For example, when the fingerprint information is unenrolled (or is not enrolled) in the storage in the fingerprint smart card 100, the first authentication is performed. For example, when the first authentication is successfully completed, the fingerprint information is received, and the second authentication is performed. For example, when the second authentication is successfully completed, the fingerprint information may be stored in the storage in the fingerprint smart card 100.

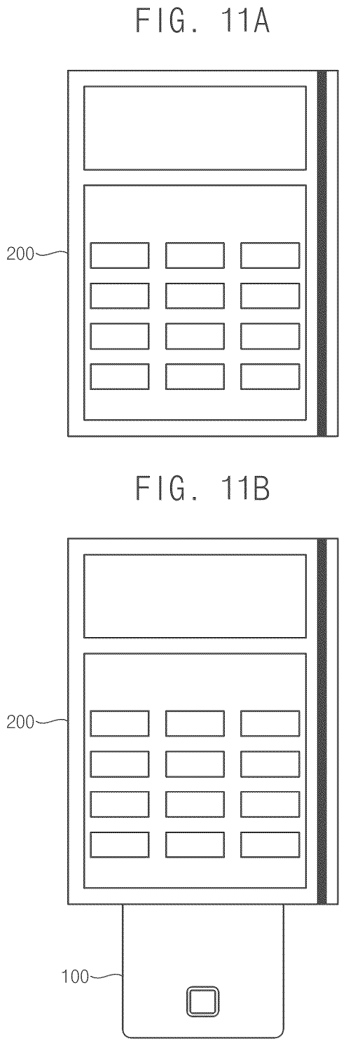

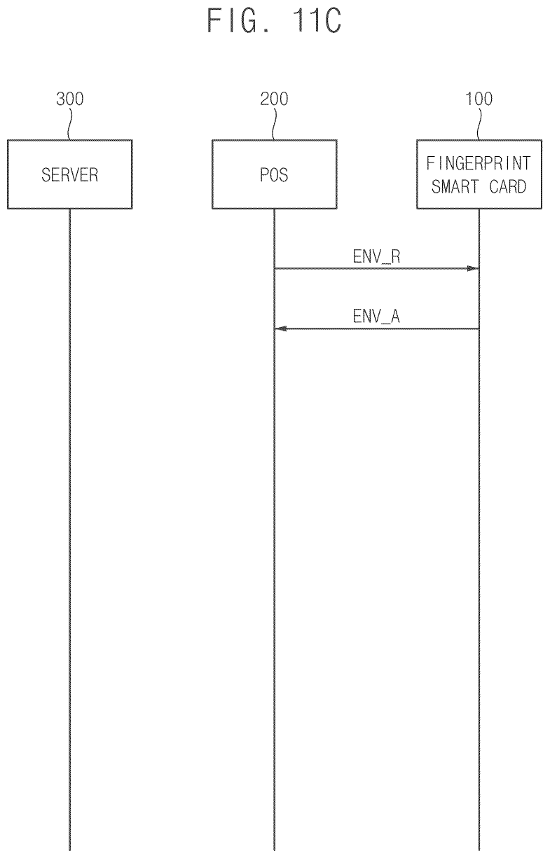

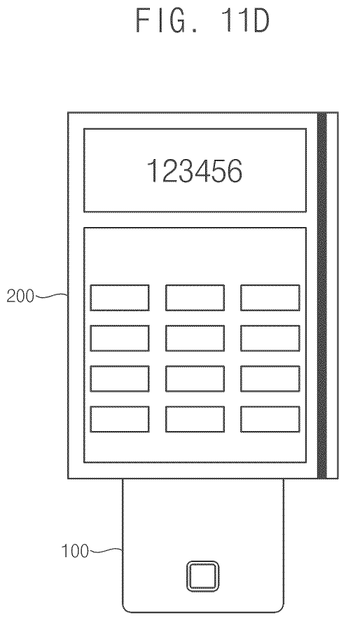

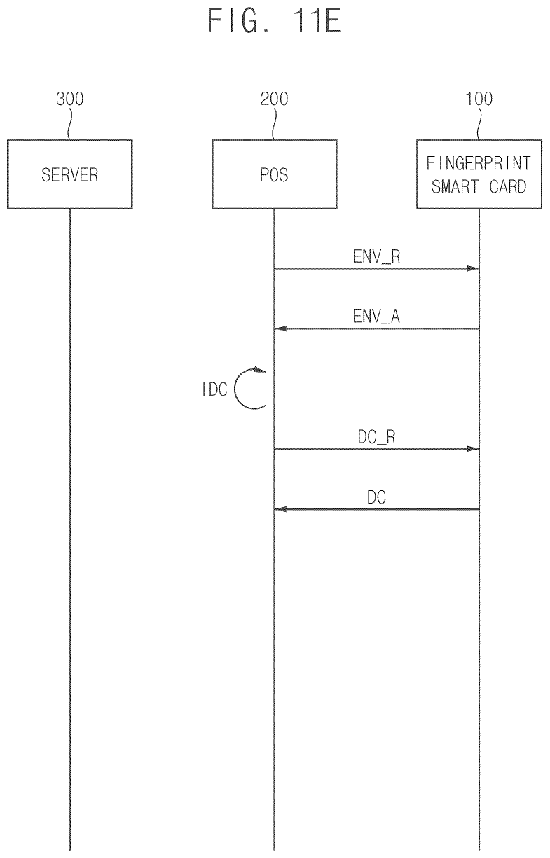

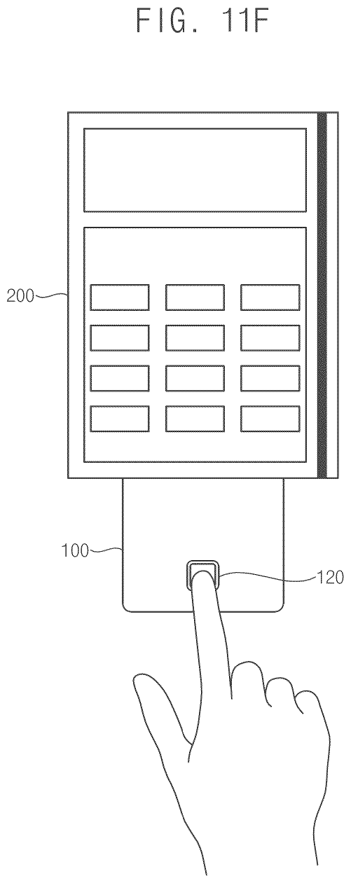

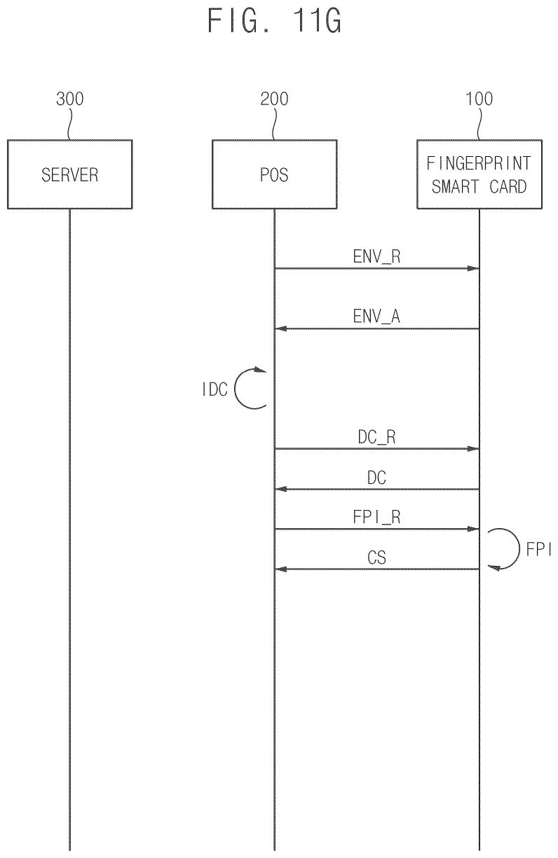

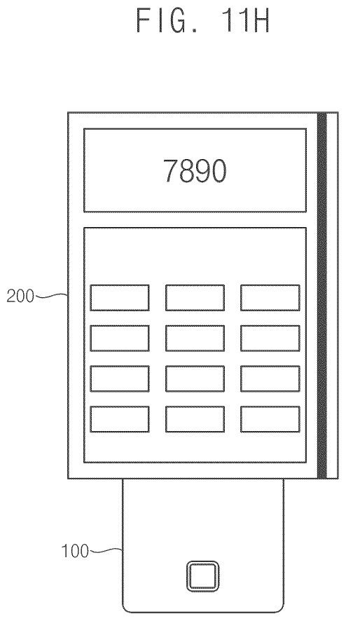

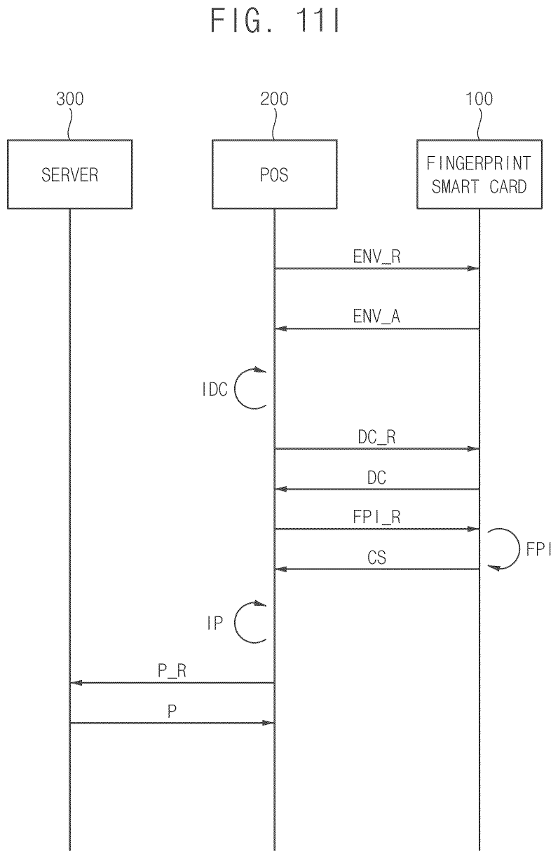

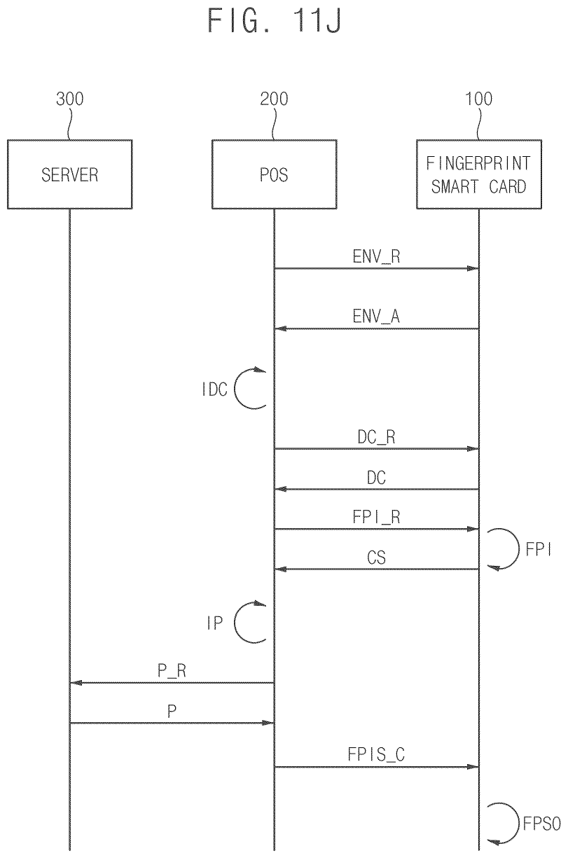

FIGS. 11A, 11B, 11C, 11D, 11E, 11F, 11G, 11H, 11I, and 11J are diagrams for describing a fingerprint enrollment method of a fingerprint smart card according to some example embodiments.

Referring to FIGS. 11A to 11J, some example embodiments of performing the operations S100 to S500 in FIG. 1 using the fingerprint enrollment system 500 of FIG. 10 are illustrated. Hereinafter, the descriptions repeated with or overlapping with descriptions of FIG. 1 will be omitted in the interest of brevity.

As illustrated in FIG. 11A, at the beginning of operation, the POS terminal 200 may not be communicating with any payment method. Although not illustrated in detail, the POS terminal 200 may call a payment protocol.

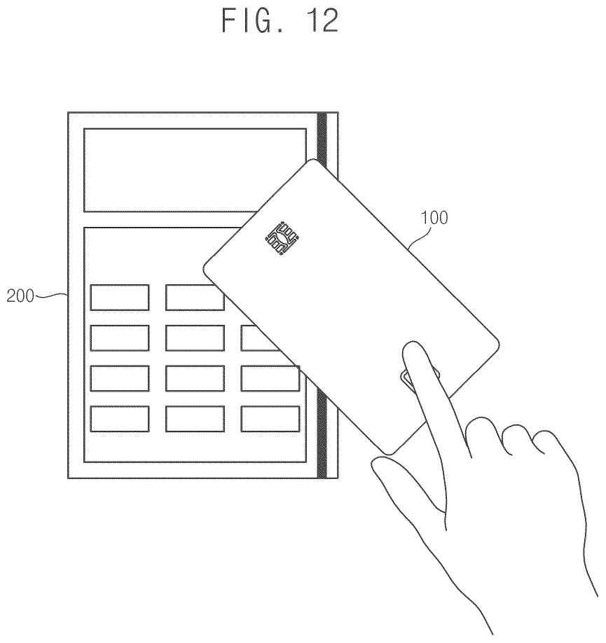

As illustrated in FIG. 11B, communication is established between the POS terminal 200 and the fingerprint smart card 100, and it may be determined whether fingerprint information is enrolled in the fingerprint smart card 100. Although some example embodiments are described in FIG. 11B based on the case where the POS terminal 200 communicates with the fingerprint smart card 100 in a direct contact manner, as will be described with reference to FIG. 12, the POS terminal 200 may communicate with the fingerprint smart card 100 in a contactless manner.

As illustrated in FIG. 11C, the POS terminal 200 may transmit an enrollment confirmation request ENV_R to the fingerprint smart card 100. The fingerprint smart card 100 may confirm whether the fingerprint information is stored in the storage based on the enrollment confirmation request ENV_R. The fingerprint smart card 100 may transmit an enrollment confirmation response ENV_A to the POS terminal 200. FIG. 11C may represent the operation S100 in FIG. 1.

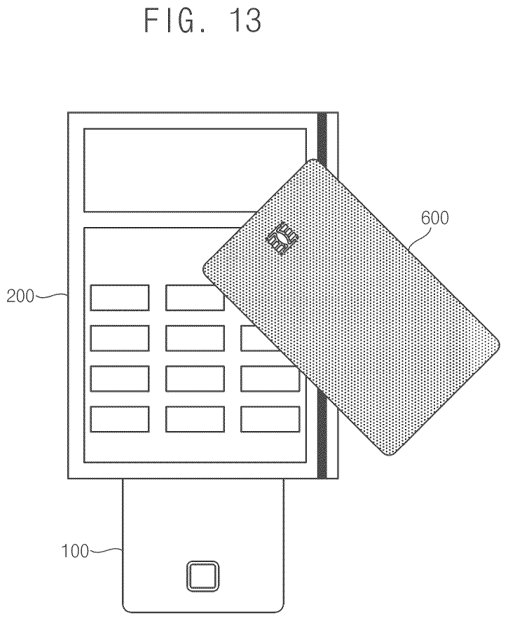

As illustrated in FIG. 11D, when the fingerprint information is not stored in the storage in the fingerprint smart card 100, the first authentication may be performed based on the user authentication means corresponding to the fingerprint smart card 100. Some example embodiments are described in FIGS. 11A to 11J based on the case where the user authentication means is a six digit code. However, example embodiments are not limited thereto, and as will be described with reference to FIG. 13, the user authentication means may be or may include the user information. For example, an input digit code (e.g., ‘123456’) may be input through an input circuit in the POS terminal 200. Although an example of the input digit code is illustrated as displayed on an output circuit in the POS terminal 200 in FIG. 11D, example embodiments are not limited thereto, and the input digit code may be displayed in encrypted form (e.g., ‘******’) or may not be displayed on the output circuit.

As illustrated in FIG. 11E, the POS terminal 200 may transmit an input digit code request DC_R to the fingerprint smart card 100. The fingerprint smart card 100 may transmit an input digit code IDC based on the input digit code request DC_R. For example, the input digit code IDC may be input by a user through the input circuit in the POS terminal 200. The POS terminal 200 may receive an N digit code DC (N is a positive integer) from the fingerprint smart card 100. For example, the N digit code DC may be referred to as a six digit code DC. The POS terminal 200 may determine whether the input digit code IDC is identical to, or matches, the six digit code DC. When the input digit code IDC is identical to, or matches, the six digit code DC, it may be determined that the first authentication is successfully completed. FIG. 11E may represent the operations S100 to S200 in FIG. 1.

As illustrated in FIG. 11F, when the first authentication is successfully completed, the fingerprint information may be received. For example, the fingerprint information may be obtained by the fingerprint sensor 120 in the fingerprint smart card 100. Although some example embodiments are described in FIG. 11F based on the case where an index finger of the fingers touches the fingerprint sensor 120, example embodiments are not limited thereto, and the fingerprint information may be obtained by touching a thumb of the fingers to the fingerprint sensor 120.

As illustrated in FIG. 11g, the POS terminal 200 may transmit a fingerprint information input request FPI_R to the fingerprint smart card 100. The fingerprint smart card 100 may receive fingerprint information FPI based on the fingerprint information input request FPI_R. For example, the fingerprint information FPI may not be permanently stored in the storage and may be temporarily stored in the storage until the second authentication is successfully completed. After the fingerprint information FPI is completely, (or substantially), received, the fingerprint smart card 100 may transmit a fingerprint information reception completion signal CS to the POS terminal 200. FIG. 11g may represent the operations S100 to S300 in FIG. 1.

As illustrated in FIG. 11H, the second authentication may be performed based on the PIN code corresponding to the fingerprint smart card 100 and the server. For example, the PIN code may be a four digit code. For example, an input PIN code (e.g., ‘7890’) may be input through the input circuit in the POS terminal 200. Although an example of the input PIN code is illustrated as displayed on the output circuit in the POS terminal 200 in FIG. 11D, example embodiments are not limited thereto, and the input PIN code may be displayed in encrypted form (e.g., ‘****’) or may not be displayed on the output circuit. For example, when the second authentication is successfully completed, the fingerprint information received in FIG. 11F may be stored in the fingerprint smart card 100.

As illustrated in FIG. 11I, the POS terminal 200 may receive an input PIN code IP based on the fingerprint information reception completion signal CS. For example, the input PIN code IP may be input by the user through the input circuit in the POS terminal 200. The POS terminal 200 may transmit a PIN code request P_R to the server 300. The POS terminal 200 may receive a PIN code P from the server 300 based on the PIN code request P_R. The POS terminal 200 may determine whether the input PIN code IP is identical to, or matches, the PIN code P. When the input PIN code IP is identical to, or matches, the PIN code P, it may be determined that the second authentication is successfully completed. FIG. 11I may represent the operations S100 to S400 in FIG. 1.

As illustrated in FIG. 11J, the POS terminal 200 may transmit a fingerprint information storage request FPIS_C to the fingerprint smart card 100. The fingerprint smart card 100 may perform a fingerprint information storage operation FPSO based on the fingerprint information storage request FPIS_C. For example, the fingerprint information storage operation FPSO may be an operation of storing the fingerprint information in the storage in the fingerprint smart card 100. FIG. 11J may represent the operations S100 to S500 in FIG. 1.

FIG. 12 is a diagram illustrating an example of establishing communication between a POS terminal in a fingerprint enrollment method of a fingerprint smart card and a fingerprint smart card according to some example embodiments.

Referring to FIG. 12, communication is established between the POS terminal 200 and the fingerprint smart card 100, and it may be determined whether the fingerprint information is enrolled in the fingerprint smart card 100. For example, the POS terminal 200 may communicate with the fingerprint smart card 100 in a contactless manner. For example, the contactless manner may represent a case of communication without inserting the fingerprint smart card 100 into the POS terminal 200. For example, the contactless manner may include a near field communication (NFC).

FIG. 13 is a diagram illustrating an example of a first authentication in a fingerprint enrollment method of a fingerprint smart card according to some example embodiments.

Referring to FIG. 13, the first authentication may be performed based on the user authentication means corresponding to the fingerprint smart card 100. For example, the user authentication means may be the user information associated with the user authorized to use the fingerprint smart card 100. For example, it may be determined whether the user information corresponds to credit card information for a credit card 600 that is different from the fingerprint smart card 100. For example, the user information may be compared with input user information obtained from the credit card information.

For example, communication may be established between the POS terminal 200 and the credit card 600. For example, the POS terminal 200 may recognize a card number (e.g., sixteen digit number) of the credit card 600 and may receive a user's identification number corresponding to the card number of the credit card 600 from the server. For example, the POS terminal 200 may determine whether the user's identification number corresponding to the card number of the credit card 600 is identical to, or matches, the user's identification number corresponding to the fingerprint smart card 100.

As illustrated in FIG. 13, when the fingerprint smart card 100 communicates with the POS terminal 200 in a direct contact manner, the credit card 600 may communicate with the POS terminal 200 in a contactless manner. Although some example embodiments are described in FIG. 13 based on the case where communication is established between the POS terminal 200 and the credit card 600, and the POS terminal 200 automatically recognizes the credit card information, example embodiments are not limited thereto, the user may manually input the credit card information.

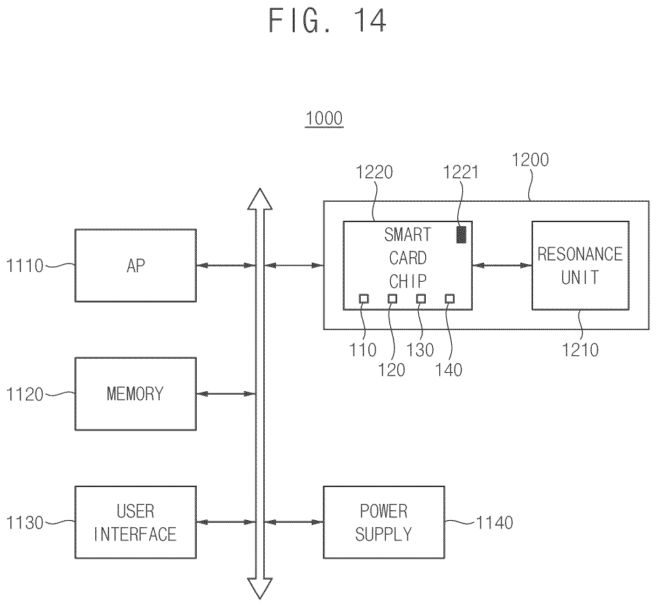

FIG. 14 is a block diagram illustrating an electronic system including a fingerprint smart card according to some example embodiments.

Referring to FIG. 14, an electronic device 1000 includes an application processor 1110, a smart card 1200, a memory device 1120, a user interface 1130 and a power supply 1140. In some example embodiments, the electronic system 1000 may be a mobile phone, a smart phone, a personal digital assistant (PDA), a portable multimedia player (PMP), a digital camera, a music player, a portable game console, a navigation system, a laptop computer, or the like.

The application processor 1110 may control overall operations of the electronic system 1000. The application processor 1110 may execute applications, such as a web browser, a game application, a video player, etc. In some example embodiments, the application processor 1110 may include a single core or multiple cores. For example, the application processor 1110 may be a multi-core processor, such as a dual-core processor, a quad-core processor, a hexa-core processor, etc. The application processor 1110 may include an internal or external cache memory.

The memory device 1120 may store data required, or sufficient, for an operation of the electronic system 1000. For example, the memory device 1120 may store a boot image for booting the electronic system 1000, output data to be outputted to an external device and/or input data received from the external device. For example, the memory device 1120 may be an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM) and/or a ferroelectric random access memory (FRAM).

The smart card 1200 may include a matching circuit 1210 and/or a smart card chip 1220 and the smart card chip 1220 includes a connection terminal 1221. The smart card chip 1220 may receive voltage from an external card reader through the matching circuit 1210 in a contactless manner and may exchange data with the external card reader. The smart card chip 1220 may receive voltage from an external card reader through the connection terminal 1221 in a direct contact manner and may exchange data with the external card reader.

The smart card 1200 may include the fingerprint smart card according to some example embodiments described above with reference to FIG. 8. For example, the smart card chip 1220 included in the smart card 1200 may include a communicator 110, a fingerprint sensor 120, a storage 130, and/or a controller 140 in FIG. 8. For example, when the fingerprint information is unenrolled (or is not enrolled) in the storage 130, the smart card 1200 may perform the first authentication based on the user authentication means corresponding to the fingerprint smart card 100 and the POS terminal. For example, when the first authentication is successfully completed, the fingerprint information is received by the fingerprint sensor 120, and the second authentication is performed based on the PIN code corresponding to the fingerprint smart card 100 and the server. For example, when the second authentication is successfully completed, the fingerprint information may be stored in the storage 130.

In some example embodiments, the smart card 1200 may be implemented including physical components. In some example embodiments, at least some of the components of the smart card 1200 may not be physical components and may be implemented to perform the functions of the smart card 1200 using components included in the electronic system 1000. For example, when the electronic system 1000 is a smart phone, an application may be executed to perform the function of the smart card 1200. For example, a fingerprint sensor included in the smart phone may be used as the fingerprint sensor 120.

The user interface 1130 may include at least one input device, such as a keypad and/or a touch screen, and/or at least one output device, such as a speaker and/or a display device. The power supply 1140 may supply a power supply voltage to the electronic system 1000.

In some example embodiments, the electronic device 1000 may further include an image processor, and/or a storage device, such as a memory card, a solid state drive (SSD), a hard disk drive (HDD) and/or a compact disc-read only memory (CD-ROM).

In some example embodiments, the electronic device 1000 and/or components of the electronic device 1000 may be packaged in various forms, such as package on package (POP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), and/or wafer-level processed stack package (WSP).

Some example embodiments may be applied to fingerprint enrollment methods of fingerprint smart cards and any cards, electronic devices and systems including the performing the fingerprint enrollment method of fingerprint smart card.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The foregoing is illustrative of some example embodiments and is not to be construed as limiting thereof. Although some example embodiments have been described, those skilled in the art will readily appreciate that many modifications are possible in the example embodiments without materially departing from the novel teachings and advantages of the example embodiments. Accordingly, all such modifications are intended to be included within the scope of the example embodiments as defined in the claims. Therefore, it is to be understood that the foregoing is illustrative of some example embodiments and is not to be construed as limited to the specific example embodiments disclosed, and that modifications to some example embodiments, as well as some other example embodiments, are intended to be included within the scope of the appended claims.

What is claimed is:

1. A fingerprint enrollment method of a fingerprint smart card configured to communicate with a server and to enroll fingerprint information through a point of sale (POS) terminal, the method comprising:
determining whether the fingerprint information is enrolled in the fingerprint smart card;
performing a first authentication based on a user authenticator corresponding to the fingerprint smart card, in response to determining the fingerprint information is not enrolled in the fingerprint smart card;
receiving the fingerprint information, in response to the first authentication being successfully completed;
performing a second authentication based on the server and a personal identification number (PIN) code corresponding to the fingerprint smart card;
storing the fingerprint information in the fingerprint smart card, in response to the second authentication being successfully completed; and
omitting the first authentication and the second authentication, in response to determining the fingerprint information is enrolled in the fingerprint smart card.

2. The fingerprint enrollment method of claim 1, wherein the fingerprint smart card includes a storage, and
wherein the user authenticator includes an N digit code, N being a positive integer, and
wherein the N digit code is stored in the storage.

3. The fingerprint enrollment method of claim 2, wherein the performing the first authentication includes:
receiving an input digit code;
determining that the first authentication is successfully completed in response to the input digit code matching the N digit code; and
determining that the first authentication fails in response to the input digit code not matching the N digit code.

4. The fingerprint enrollment method of claim 1, wherein the user authenticator includes user information associated with a user authorized to use the fingerprint smart card, and the user information is stored in the server.

5. The fingerprint enrollment method of claim 4, wherein the performing the first authentication includes:
establishing communication between the POS terminal and a credit card different from the fingerprint smart card;
obtaining credit card information for the credit card;
determining that the first authentication is successfully completed in response to the credit card information corresponding with the user information; and
determining that the first authentication fails in response to the credit card information not corresponding with the user information.

6. The fingerprint enrollment method of claim 1, wherein the PIN code is stored in the server.

7. The fingerprint enrollment method of claim 6, wherein the performing the second authentication includes:
receiving an input PIN code;
determining that the second authentication is successfully completed in response to the input PIN code matching the PIN code; and
determining that the second authentication fails in response to the input PIN code not matching the PIN code.

8. The fingerprint enrollment method of claim 1, further comprising:
performing a fingerprint payment protocol in response to the fingerprint information being enrolled in the fingerprint smart card.

9. The fingerprint enrollment method of claim 8, wherein the fingerprint smart card includes a fingerprint sensor, and
wherein the performing the fingerprint payment protocol includes:
obtaining input fingerprint information using the fingerprint sensor;
performing a payment in response to the input fingerprint information matching the fingerprint information, performing a payment; and
outputting a payment error in response to the input fingerprint information not matching the fingerprint information.

10. The fingerprint enrollment method of claim 9, further comprising:
calling a payment protocol stored in the POS terminal; and
establishing communication between the POS terminal and the fingerprint smart card, and
wherein the payment protocol includes the fingerprint payment protocol.

11. The fingerprint enrollment method of claim 10, wherein the POS terminal and the fingerprint smart card are configured to communicate with each other in a direct contact manner.

12. The fingerprint enrollment method of claim 10, wherein the POS terminal and the fingerprint smart card are configured to communicate with each other in a contactless manner.

13. The fingerprint enrollment method of claim 1, wherein the fingerprint smart card includes a fingerprint sensor, and
wherein the fingerprint information is generated by touching a finger to the fingerprint sensor at least twice.

14. The fingerprint enrollment method of claim 1, wherein the fingerprint smart card includes a storage, and
wherein the fingerprint information is stored in the storage.

15. A fingerprint smart card configured to communicate with a server and to enroll fingerprint information through a point of sale (POS) terminal, the fingerprint smart card comprising:
a communicator configured to communicate with the POS terminal;
a fingerprint sensor configured to obtain the fingerprint information;
a storage configured to store the fingerprint information; and
a controller configured to cause the fingerprint smart card to,
receive fingerprint information by the fingerprint sensor in response to a first authentication being successfully completed, the first authentication being performed, based on the POS terminal and a user authenticator corresponding to the fingerprint smart card, in response to the fingerprint information not being enrolled in the storage, and
store the fingerprint information in the storage in response to a second authentication, performed based on the server and a personal identification number (PIN) code corresponding to the fingerprint smart card, being successfully completed.

16. The fingerprint smart card of claim 15, wherein the user authenticator includes an N digit code, N being a positive integer, and
wherein the N digit code is stored in the storage.

17. A fingerprint enrollment system comprising:
a fingerprint smart card including a storage configured to store fingerprint information;
a point of sale (POS) terminal;
a server storing a personal identification number (PIN) code; and
processing circuitry configured to cause the system to
determine whether the fingerprint information is enrolled in the storage in the fingerprint smart card,
perform a first authentication based on a user authenticator corresponding to the fingerprint smart card, in response to determining the fingerprint information is not enrolled in the storage in the fingerprint smart card,
receive the fingerprint information in response to the first authentication being successfully completed,
perform a second authentication based the PIN code corresponding to the fingerprint smart card, and
store the fingerprint information in the storage in the fingerprint smart card in response to the second authentication being successfully completed.

18. The fingerprint enrollment system of claim 17, wherein the POS terminal includes:
a terminal communication circuit configured to communicate with the fingerprint smart card and the server; and
an input circuit configured to receive an input digit code.

19. The fingerprint enrollment system of claim 18, wherein the user authenticator includes an N digit code, N being a positive integer,
wherein the N digit code is stored in the storage in the fingerprint smart card, and
wherein, the processing circuitry is configured to determine that the first authentication is successfully completed in response to the input digit code received to the input circuit in the POS terminal matching the N digit code.

20. The fingerprint enrollment system of claim 18, wherein the user authenticator includes user information associated with a user authorized to use the fingerprint smart card, and the user information is stored in the server, and
wherein the processing circuitry is further configured to
establish communication between the terminal communication circuit in the POS terminal and a credit card different from the fingerprint smart card,
obtain credit card information for the credit card is, and
determine that the first authentication is successfully completed in response to the credit card information corresponding to the user information.
